(19) United States
(12) Patent Application Publication
(10) Pub. No.: US 2022/0397261 A1
(43) Pub. Date: Dec. 15, 2022

(54) BUILT-IN LIGHTING APPARATUS

(71) Applicant: IGUZZINI ILLUMINAZIONE S.P.A., Recanati (IT)

(72) Inventor: Massimo Gattari, Potenza Picena (IT)

(21) Appl. No.: 17/755,475

(22) PCT Filed: Nov. 10, 2020
(86) PCT No.: PCT/IB2020/060570

§ 371 Date: Apr. 29, 2022

(30) Foreign Application Priority Data
Nov. 13, 2019 (IT) 102019000021057
Mar. 20, 2020 (IT) 102020000005953

(51) Int. Cl. F21V 7/00; F21V 13/04; F21V 7/06

(52) U.S. Cl. CPC F21V 7/0091; F21V 13/04; F21V 7/06

(57) ABSTRACT

A recessed lighting apparatus comprising a cap provided with an apex comprising a first opening, adapted to accommodate at least one lighting source, and a second opening, of greater dimensions than the first opening, adapted to emit the light flow emitted from the lighting source. Starting from the interior of the apparatus towards the exterior of the apparatus, the cap can comprise a first cap made of a transparent material acting as a catadioptric reflector and a second cap made of an opaque material which is separated from said first cap by a gap.

### CROSS-REFERENCE TO RELATED APPLICATIONS

This application claims priority to PCT International Application No. PCT/IB2020/060570 filed on Nov. 10, 2020, which application claims priority to Italian Patent Application No. 102019000021057 filed on Nov. 13, 2019 and Italian Patent Application No. 102020000005953 filed on Mar. 20, 2020, the disclosures of which are expressly incorporated herein by reference.

### STATEMENT RE: FEDERALLY SPONSORED RESEARCH/DEVELOPMENT

Not applicable.

### BACKGROUND OF THE INVENTION

### Field of the Invention

The present invention relates to the technical field of lighting apparatuses, and in particular to the technical field of recessed lighting apparatuses comprising means for optimizing the light beam emitted.

### Background Art

An important category of lighting apparatuses comprises recessed lighting apparatuses. Lighting apparatuses of this type can be installed thus minimizing or eliminating the overall dimensions and protrusions with respect to the edge of the surface accommodating them.

Such apparatuses are designed to have a low visual impact as little of the lighting apparatus remains visible when installed. Recessed lighting apparatuses are frequently provided with an edge which delimits the light emission opening of the apparatus to improve the appearance of the lamp and conceal the hole made in the structure accommodating the apparatus.

Recessed lighting apparatuses can be installed in a false ceiling, a wall, as well as in wardrobes, bookcases, kitchen furniture and all applications where architectural needs or limited overall dimensions require the use of apparatuses which do not protrude with respect to the edge of the wall accommodating them.

In recessed lighting apparatuses, the volume available for the optical unit—comprising the lighting sources and means for directing the light beam produced, optical filters and reflectors—is generally limited by the depth of the recess which should accommodate the apparatus, furthermore, in this type of apparatuses, the entire light flow emitted must be conveyed towards the main emission direction, orthogonal to the plane of the wall in which the apparatus is installed. As a result, the installation surface remains dark as it is not possible for the aforesaid constructional features of these apparatuses to direct the light emission towards the surface accommodating the apparatus, unless product parts protruding therefrom are inserted, conveniently redirecting the light with apparent impacts on the esthetics of the lighting apparatus itself. In the case of apparatuses being installed in the ceiling, the inadequate lighting of the installation surface also creates an unpleasant “cave” effect, which can result in a sense of oppression and distorted perception of the spaces, thus also increasing the overall feeling of discomfort (often referred to as eye discomfort) and dazzle.

Workplace safety and hygiene regulations exist, such as the standard EN12464, for example, which define the parameters required for the correct lighting of workplaces and also take into account the undesired phenomena described, linked to recessed lighting sources.

In order to overcome the aforesaid problem, in addition to the possibility of inserting product parts protruding from the product and conveniently redirecting the light, another possible solution to the aforesaid problem provides for the use of additional apparatuses the purpose of which is only to light up the installation surface so as to improve the overall appearance of the lit space. It is apparent that both these solutions have a considerable impact on the lighting apparatus, both in terms of costs and feasibility.

Therefore, it is an object of the present invention to introduce a recessed lighting apparatus characterized by a structure which allows to achieve an optimized emission both in terms of light output and in terms of quality and type of lighting emitted so as to direct a part of the light emission towards the installation surface without adding further external devices adapted to correct the emitted light flow.

### SUMMARY OF THE INVENTION

The present description refers to a lighting apparatus for recessed mounting, used for lighting indoor or outdoor spaces.

Said lighting apparatus comprises an optical compartment comprising, in turn, a first transparent cap, preferably having a roto-symmetrical geometry and provided with two openings, one of smaller dimensions, adapted to receive at least one lighting source, the other, of larger dimensions, adapted to emit the light emission produced by the apparatus.

Said at least one lighting source is associated with convenient power supply means and convenient means for dissipating the heat produced.

Said first transparent cap can be associated with a second cap made of an opaque material, arranged in an external position to said first cap.

Preferably, said first transparent cap is made of a plastic material.

Said first cap is characterized by an inner surface, which can be smooth or faceted, and an outer faceted surface with almost-parallel longitudinal lines or with curved longitudinal lines or again with horizontal lines, and comprising grooves having a certain pitch and preferably a triangular, or almost-triangular profile. The faceting grooves run longitudinally and extend between the two aforesaid openings lying on planes orthogonal to the planes on which the surfaces of the aforesaid two openings lie.

Advantageously, said first cap made of a plastic material comprises a flap which surrounds the second cap opening. Said flap is characterized by a certain width and has a multiple utility: in addition to the purpose of concealing the hole made in the structure which accommodates the apparatus and providing a useful stop for facilitating the stable mounting of the lighting apparatus, such as in a false ceiling, the flap is configured to light up the zone of the surrounding apparatus. In fact, a part of the lighting produced by the sources used remains “trapped” in a certain manner inside the first layer of the cap so as to light it up. This allows said flap to act as an additional lighting source, which also lights up the installation surface illuminating it.

Such a feature is advantageous because it allows to reduce the contrast between the installation surface, which would otherwise remain dark, and the mouth of the reflector, which instead emits the light flow. Additionally, it allows to increase the level of lighting of the vertical planes, giving a more balanced spatial vision of the surrounding space (due to a reduction of the contrasts).

When present, the second cap is separated from the first cap by a gap.

Said second cap is made of an opaque material, preferably of a plastic or metal material, thus, due to the presence of the small gap between said first cap made of a transparent plastic material and said second cap, the light beams emitted from said lighting sources spread inside the first transparent faceted cap, respecting the laws of refraction, when they are characterized by an angle of incidence with respect to the normal which is greater than the so-called critical angle.

The light rays emitted from said at least one lighting source are then refracted almost completely towards the interior of the cap and towards the aforesaid opening of greater dimensions, adapted to emit the light emission produced by the apparatus, thus obtaining a complete reflection inside the thickness of said first cap made of a plastic material.

When present, the second cap made of an opaque material performs the task of recovering the small portion of light beams, which will inevitably cross the first transparent detail because, being incident with a different angle from the aforesaid critical angle, they are not refracted by the aforesaid law of refraction. This allows the overall efficiency of the lighting apparatus to be maximized. Advantageously, said second cap can be made in various colors so as to obtain different types of lighting and perceptual effects and allows the interior of the false ceiling to be concealed.

### BRIEF DESCRIPTION OF THE FIGURES

Further features and advantages of the invention will become apparent from the following detailed description provided by way of example and not by way of limitation, with the aid of the Figures shown in the accompanying drawings, in which:

FIG. 1 shows a sectional view of a preferred embodiment of the lighting apparatus according to the present description;

FIG. 2 shows a perspective view of a preferred embodiment of the lighting apparatus according to the present description; and

FIG. 3 shows a detail of a perspective view of the outer surface of the transparent cap of the lighting apparatus according to the present description.

FIG. 4 shows a sectional view of another preferred embodiment of the lighting apparatus according to the present description;

FIG. 5 shows a sectional plan view of another preferred embodiment of the lighting apparatus according to the present description;

FIG. 6 shows a sectional plan view of another preferred embodiment of the lighting apparatus according to the present description.

The following description of exemplary embodiments refers to the accompanying drawings. The same reference numerals in the various drawings identify the same or similar elements. The following detailed description does not limit the invention. The scope of the invention is defined by the appended claims.

### DETAILED DESCRIPTION OF THE INVENTION

Recessed lighting apparatuses are often used for lighting indoor or outdoor spaces. One problem linked to recessed lighting apparatuses concerns the correct lighting of the surface on which the apparatus is installed, which is adapted to make the overall lighting produced comfortable for users, thus reducing the contrast.

The lighting apparatus according to the present description comprises a structure which allows to have a very high light output—almost all of the light emission of the lighting sources is effectively collected and used—and offer the right amount of lighting even on the surface on which the apparatus is installed.

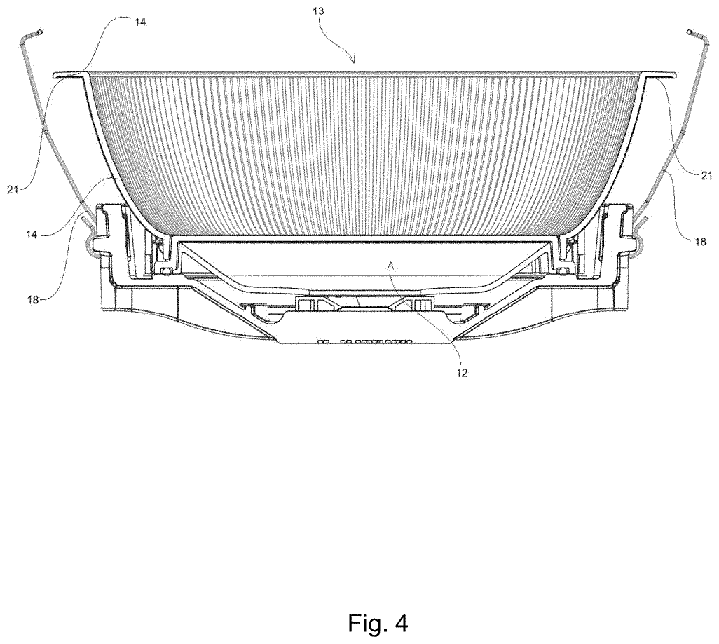

With reference to accompanying FIG. 4, the recessed lighting apparatus according to the present invention comprises an optical compartment comprising a first transparent cap 14, preferably but not necessarily having a roto-symmetrical geometry, i.e. characterized by a rotational symmetry about a main rotation axis 11, provided with an apex comprising a first opening 12 adapted to accommodate at least one lighting source and a second opening 13, of greater dimensions than the first opening, adapted to emit the light flow emitted from said one or more lighting sources. Said two openings 12, 13 preferably lie on planes which are substantially parallel and orthogonal to the aforesaid rotation axis 11. Advantageously, the aforesaid first opening 12 can be provided with a diffusing screen adapted to mix conveniently the light emitted from the at least one light source.

Said at least one lighting source is associated with convenient power supply means and convenient means for dissipating the heat produced according to practices known in the current art.

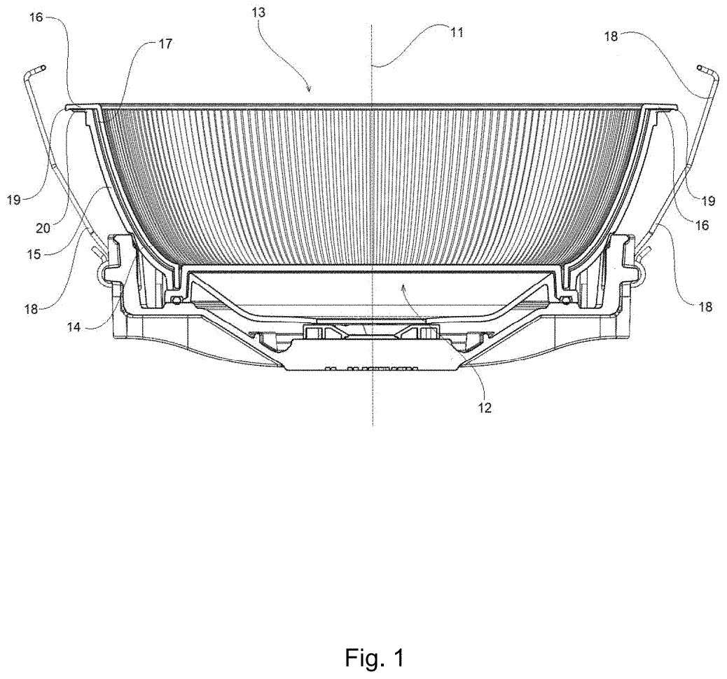

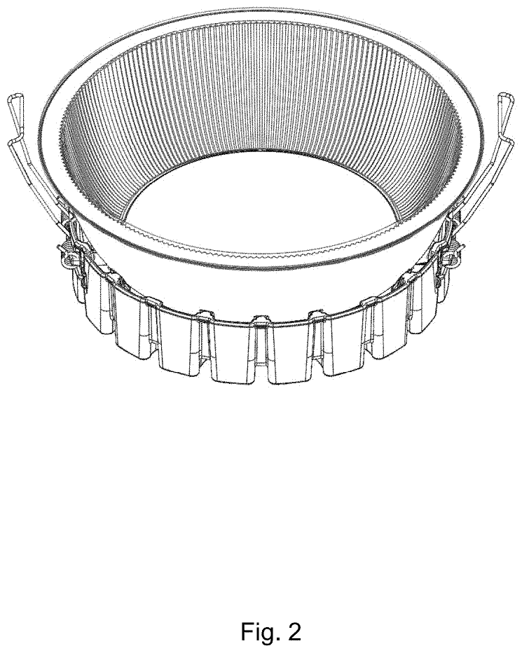

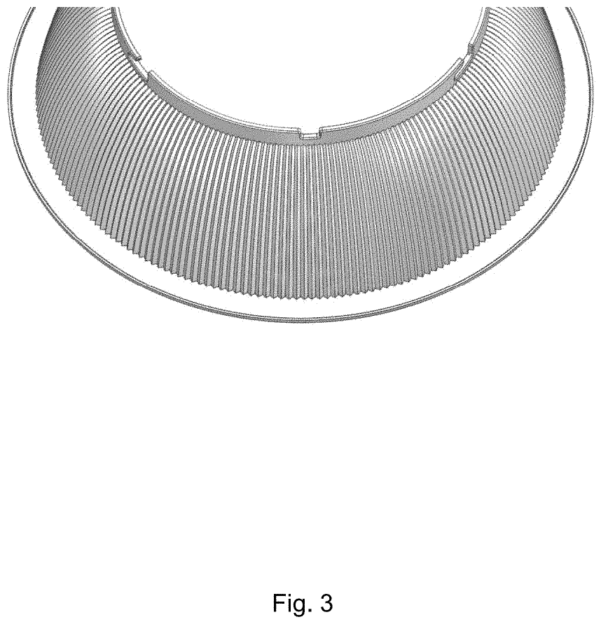

With reference to FIGS. 1 to 4, a first embodiment of said first cap is preferably further characterized by a smooth or faceted inner surface and a faceted outer surface with almost-parallel longitudinal lines and comprising grooves having a certain pitch and preferably a triangular, or almost-triangular profile. The faceting grooves run longitudinally and extend between the two aforesaid openings lying on planes orthogonal to the planes on which the surfaces of the aforesaid two openings lie.

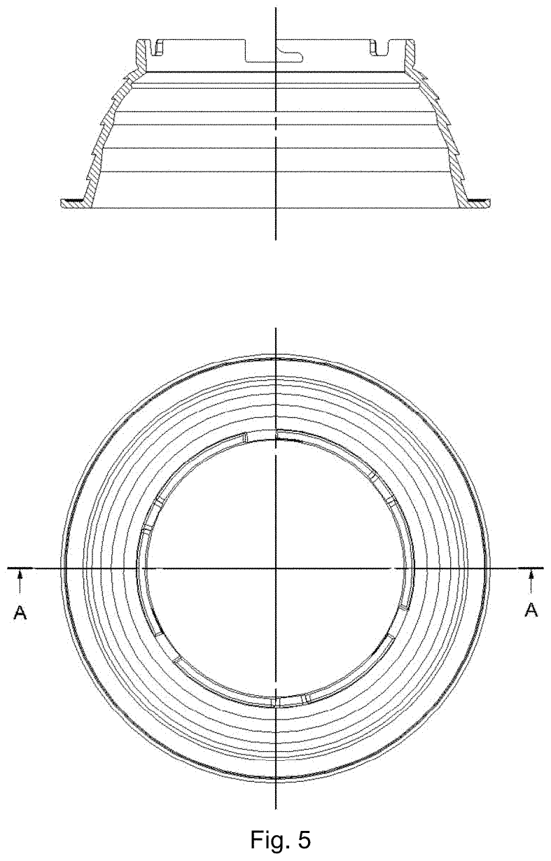

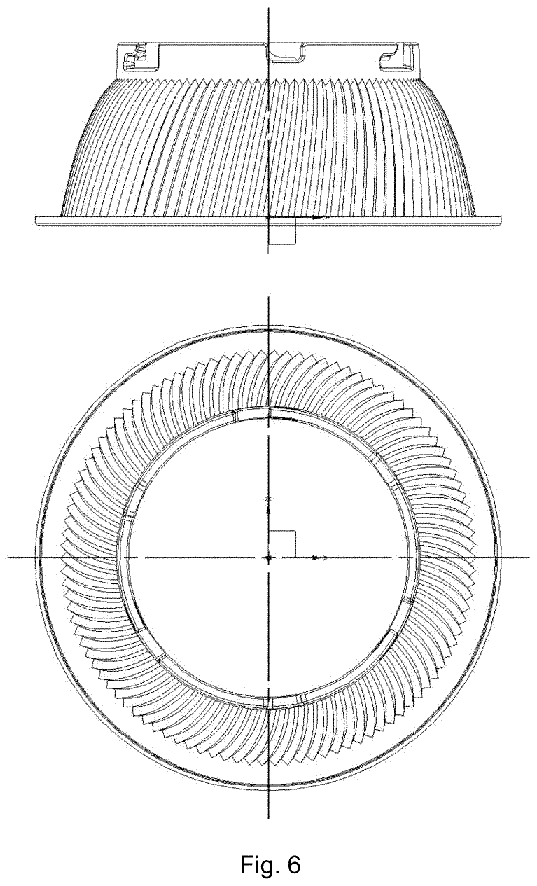

In another preferred embodiment of the apparatus according to the present description, shown in FIG. 5, said first cap is characterized by a smooth or faceted inner surface and a faceted outer surface with substantially parallel, horizontal lines. In a further preferred embodiment of the apparatus according to the present description, shown in FIG. 6, said first cap is characterized by a smooth or faceted inner surface and a faceted outer surface with curved longitudinal lines.

In the preferred embodiment of the object of the present description, shown in FIG. 1, the first cap 14 made of a transparent material can be associated with a second cap 15 made of an opaque material.

Said first transparent cap 14 is characterized by a thickness preferably between 0.25 mm and 3 mm and is preferably made of a plastic material. A preferred embodiment of the apparatus according to the present description provides for said first cap 14 being made of PMMA (polymethylmethacrylate), but other suitable plastic materials can be used, such as polycarbonate (PC), for example.

Said first cap 14, which embodies a catadioptric reflector, is also characterized by a smooth or faceted inner surface (facing the optical compartment of the lighting apparatus), and by a faceted outer surface with almost-parallel longitudinal lines which identify a plurality of grooves. Said grooves run between said two openings 12, 13 and lie on planes orthogonal to the same two openings 12, 13, preferably have a pitch between 1 mm and 6 mm, and preferably a triangular, or almost-triangular profile with rounded or shaped convex sides and vertex.

The first cap 14 further comprises a flap 16 which surrounds said second opening 13 and lies on a plane orthogonal to the aforesaid rotation axis 11. Said flap 16 is characterized by a width preferably between 3 and 25 mm and is adapted to light up due to the refraction which is experienced by a part of the light flow emitted from the source or from the lighting sources used when it impacts the inner surface of the first cap 14.

Said flap 16 can also be obtained with the outer surface, the inner surface or both glazed in order to obtain a higher mixing effect of the brightness emitted.

In addition to the lighting function, said flap 16 is also adapted to provide a useful stop for facilitating the stable mounting of the lighting apparatus, such as in a false ceiling. Advantageously, said first cap 14 is associated with fixing means to allow the installation of the lighting apparatus, such as in a false ceiling. Said fixing means can comprise, for example, at least two springs 18 adapted to press against the inner surface of the plasterboard wall so as to keep the lighting apparatus stably installed due to the counterthrust exerted by the flap 16 on the outer surface of the plasterboard wall.

When present, said second cap 15 made of an opaque material is located outside said first cap 14 and is separated from the first cap 14 by a gap 17 having a width which can preferably vary between 0.05 mm and 8 mm.

The second cap 15 recovers the part of the light flow emitted from the lighting source which is not refracted towards the interior of the lighting apparatus and does not remain inside the thickness of the first cap 14.

The light flow emitted from the at least one lighting source impacts on the inner surface of the first cap 14 and penetrates the thickness thereof, thus experiencing a first refraction. The light beam then impacts the outer surface of the first cap 14 with a certain angle of incidence to the normal on the surface itself. If said angle of incidence is greater than the critical angle

$$θ c = arcsin ( \frac{n 2}{n 1} )$$

(where n1 and n2 are the refraction indices of the two means in which the light propagates, the plastic material of the first cap 14 and the air in the gap between said first cap 14 and said second cap 15), then said light beam remains inside the body of the first cap 14 and is diffused therein.

The light flow emitted from said at least one lighting source is thus partially refracted towards the interior of the lighting apparatus and then comes out of said second opening 13, partially remains inside the thickness of the first cap 14, and partially crosses the thickness of said first cap 14 and said gap 17, finally being reflected by the second cap 15 again towards the interior of the lighting apparatus.

Advantageously, said second cap 15 can also be provided with a flap 20 at the flap of the first cap. In this case, the flap of the first cap 14 can comprise a raised edge 19 adapted to contain the flap of the second cap.

Furthermore, advantageously, also if said second cap 15 is not present, the flap 16 of the first cap can be provided with a cover element 21 made of an opaque material on the inner side, in contact with the wall on which the apparatus is installed. This cover element 21 can be made both from an opaque material strip applied inside the flap 16 and an opaque paint layer. Due to the presence of this cover element, the flap 16 of the first cap 14 will be able to conceal from sight the underlying edge of the opening made in the false ceiling, thus continuing to show the previously described illuminance.

The described structure of the lighting apparatus according to the present invention allows the overall efficiency thereof to be maximized, conveniently using a large part of the light flow emitted from the sources. Finally, said second cap 15 can be advantageously made of a plastic or metal material and can be made in various colors so as to achieve different types of lighting and perceptual effects.

In two embodiments of the apparatus according to the present invention, a first cap 14 made of PMMA (polymethylmethacrylate) and a second cap 15 made in black color, in the one case, and white color, in the other case, were used.

In the first case, we will have a higher visual comfort due to the black-colored cap. The perception of greater comfort is given by a lower emission at high angles, those close to the horizontal.

In the second case, we will have a higher luminance and a consequent increase in the vertical illuminance due to the different type of reflection of the white surface which also diffuses the light beams at high angles, precisely those closest to the horizontal.

1. A recessed lighting apparatus comprising a first cap made of a transparent material, provided with an apex comprising a first opening adapted to accommodate at least one lighting source, and a second opening, of greater dimensions than the first opening, adapted to emit the light flow emitted from said at least one lighting source, characterized in that said first cap comprises a flap which surrounds said second opening and is made of transparent material adapted to trap a part of the light flow emitted from said at least one lighting source when it impacts the inner surface of the first cap.

2. A lighting apparatus according to claim 1 wherein said first cap comprises a faceted outer surface with almost-parallel longitudinal lines which identify a plurality of grooves.

3. A lighting apparatus according to claim 2 wherein said grooves run between said two openings and lie on planes orthogonal to the same two openings, have a pitch between 1 mm and 6 mm and a triangular or almost-triangular profile.

4. A lighting apparatus according to claim 1 wherein said first cap comprises a faceted outer surface with substantially parallel horizontal lines.

5. A lighting apparatus according to claim 1 wherein said first cap comprises a faceted outer surface with curved longitudinal lines.

6. A lighting apparatus according to claim 1 wherein said first cap comprises a smooth inner surface.

7. A lighting apparatus according to claim 1 wherein the flap of the first cap is provided with a cover element made of an opaque material on the inner side facing the wall on which the apparatus is installed.

8. A lighting apparatus according to claim 7 wherein said cover element is made from a strip of opaque material applied inside the flap or from a layer of opaque paint applied inside the flap.

9. A lighting apparatus according to claim 1 wherein it comprises a second cap made of an opaque material.

10. A lighting apparatus according to claim 1 wherein said second cap is separated from said first cap by a gap.

11. A lighting apparatus according to claim 1 wherein said first cap has a rotational symmetry about a main rotation axis which is substantially orthogonal to the lying planes of said two openings.

12. A lighting apparatus according to claim 1 wherein said first cap is made of a plastic material.

13. A lighting apparatus according to claim 12 wherein said first cap is made of a material selected from the group comprising polymethylmethacrylate, PMMA, and polycarbonate, PC.

14. A lighting apparatus according to claim 9 wherein said second cap is made of a plastic or metal material.

15. A lighting apparatus according to claim 9 wherein said second cap is made in black or white color.

16. A lighting apparatus according to claim 9 wherein said gap has a width between 0.05 mm and 6 mm.

17. A lighting apparatus according to claim 9 wherein said second cap comprises a flap at the flap of said first cap.

18. A lighting apparatus according to claim 17 wherein the flap of the first cap comprises a raised edge adapted to contain the flap of the second cap.

19. A lighting apparatus according to claim 1 wherein said first cap is associated with fixing means to allow the installation of the lighting apparatus in a false ceiling.

20. A lighting apparatus according to claim 19 wherein said fixing means comprise at least two springs adapted to press against the inner surface of the plasterboard wall.
